(19) United States
(12) Patent Application Publication
(10) Pub. No.: US 2023/0308395 A1
(43) Pub. Date: Sep. 28, 2023

(54) COMMUNICATION SYSTEM, DEVICE, METHOD AND PROGRAM FOR SHAPING

(71) Applicant: NIPPON TELEGRAPH AND TELEPHONE CORPORATION, Tokyo (JP)

(72) Inventors: Tatsuya FUKUI, Musashino-shi, Tokyo (JP); Katsuya MINAMI, Musashino-shi, Tokyo (JP); Yuki SAKAUE, Musashino-shi, Tokyo (JP)

(73) Assignee: NIPPON TELEGRAPH AND TELEPHONE CORPORATION, Tokyo (JP)

(21) Appl. No.: 18/021,260

(22) PCT Filed: Aug. 20, 2020
(86) PCT No.: PCT/JP2020/031406

§ 371 Date: Feb. 14, 2023

(51) Int. Cl. H04L 47/22; H04L 47/193; H04L 47/12

(52) U.S. Cl. CPC H04L 47/22; H04L 47/193; H04L 47/12

(57) ABSTRACT

An object of the present disclosure is to reduce traffic burstiness in a TCP without causing a window size expansion delay and a decrease in maximum throughput.

A system of the present disclosure is a communication system for transmitting a packet from a transmission terminal to a reception terminal, the communication system including a congestion control unit that performs congestion control of a packet transmitted from the transmission terminal, and a delay control shaping unit that changes a set value of delay control shaping based on a setting of a congestion window size on which the congestion control unit performs congestion.

### TECHNICAL FIELD

The present disclosure relates to balancing both reduction of traffic burstiness and realization of high throughput in TCP communication.

### BACKGROUND ART

As the bandwidth of a network itself has expanded significantly with the spread of 5G (5th Generation) and high-speed optical communication services, the transport layer, represented by TCP (Transmission Control Protocol), has been tuned to take full advantage of the network by performing tuning such as increasing the maximum window size and increasing the speed of window size expansion to increase the speed of throughput increase (NPL 1, for example).

On the other hand, when such tuning is performed, a large number of packets are emitted from a transmission point at a time, increasing the traffic burstiness. When traffic is bursty, a plurality of traffic collisions can cause packet loss by overflowing buffers of the network device, resulting in reduced throughput and longer time to complete the transmission of a file.

As a method for suppressing packet loss due to a burst traffic collision, there is a method for applying traffic shaping (conventional method 1). A burst traffic can be leveled by deploying traffic shaping functions inside or behind the transmission point. There is a method of applying delay control shaping that performs traffic shaping based on the allowable delay fluctuation of NW. (Conventional Method 2)

However, the conventional method 1 has two problems. The first problem is that it is difficult to set an optimum bandwidth set value for traffic shaping. When executing traffic shaping, it is necessary to set the bandwidth in advance, but it is difficult to set the necessary and sufficient bandwidth because the bandwidth available to the flow is unpredictable due to the ever-changing conditions inside the network. If a relatively large bandwidth set value is applied, the leveling of the burst traffic becomes insufficient, so that the original purpose cannot be achieved. When a small bandwidth set value is applied, a bandwidth that should be originally used cannot be used, lowering the maximum throughput.

The second problem is that the bandwidth delay product is increased due to delay fluctuation caused by traffic shaping, and the maximum throughput is lowered. When traffic shaping is executed, a communication delay until reaching a receiving point appears to increase, which increases the bandwidth delay product and reduces the maximum throughput.

The conventional method 2 can solve the problems 1 and 2 of the conventional method 1. The conventional method 2 sets the allowable delay fluctuation instead of the bandwidth, thus enabling burst traffic leveling without setting the bandwidth. In the conventional method 2, since the allowable delay fluctuation is set in advance, the increase of the bandwidth delay product can be kept within a certain range.

On the other hand, the conventional system 2 has a problem that the packet transmission is delayed by the allowable delay fluctuation even when the traffic amount is small, resulting in slow expansion of the congestion window size in the slow start phase. Therefore, there is a demand for a method for reducing traffic burstiness in a TCP while suppressing the delay in window size expansion and the decrease in the maximum throughput.

### CITATION LIST

### Non Patent Literature

[NPL 1] https://paulgrevink.wordpress.com/2017/09/08/about-long-fat-networks-and-tcp-tuning/
[NPL 2] https:/www/anritus.com/ja-jp/network-solutions/products/bandwidth-control/nf7601a
[NPL 3] “A Proposal of Delay Control Shaping for Realizing A Delay Guarantee Service,” IEICE Technical Report, vol. 119, no.7, CQ2019-7, pp. 35-40, April 2019
[NPL 4] https://www.netone.co.jp/knowledge-center/blog-column/knowledge_takumi_143/index.html

### SUMMARY OF INVENTION

### Technical Problem

An object of the present disclosure is to reduce traffic burstiness in a TCP without causing a window size expansion delay and a decrease in maximum throughput.

### Solution to Problem

The present invention proposes a method for controlling a set value of delay control shaping based on a congestion window size of a TCP.

Specifically, a system according to the present disclosure is a communication system for transmitting a packet from a transmission terminal to a reception terminal, and includes: a congestion control unit that performs congestion control of a packet transmitted from the transmission terminal; and a delay control shaping unit that changes a set value of delay control shaping based on a setting of a congestion window size on which the congestion control unit performs congestion.

Specifically, a method according to the present disclosure is a shaping method executed by a communication system transmitting a packet from a transmission terminal to a reception terminal, the shaping method including a step in which a congestion control unit performs congestion control of a packet transmitted from the transmission terminal, and a step in which a delay control shaping unit changes a set value of delay control shaping based on a setting of a congestion window size on which the congestion control unit performs congestion.

Specifically, a device according to the present disclosure is a device for performing shaping of a packet transmitted from a transmission terminal, the device receiving a packet transmitted from the transmission terminal, acquiring a congestion window size of congestion control to be performed on the packet of the transmission terminal, and changing a set value of delay control shaping based on a setting of the congestion window size.

Specifically, a program according to the present disclosure is a program for realizing a computer as each functional unit provided in a communication device according to the present disclosure, the program being a program for causing the computer to execute each of steps provided in a communication method executed by the communication device according to the present disclosure.

### Advantageous Effects of Invention

According to the present disclosure, traffic burstiness in a TCP can be reduced without causing a window size expansion delay and a decrease in maximum throughput.

### BRIEF DESCRIPTION OF DRAWINGS

FIG. 1 shows an example of traffic in TCP communication.

FIG. 2 shows a first example of shaping related to the present disclosure.

FIG. 3 shows a second example of the shaping related to the present disclosure.

FIG. 4 shows an example of shaping according to the present disclosure.

FIG. 5 shows an example of a system configuration according to Embodiment 1.

FIG. 6 shows an example of a configuration of a transmission terminal.

FIG. 7 shows an example of a configuration of a TCP communication unit.

FIG. 8 shows an example of a configuration of a delay control shaping set value changing unit.

FIG. 9 shows an example of a target burst rate setting table.

FIG. 10 shows an example of a configuration of a delay control shaping function.

FIG. 11 is a diagram for explaining a token supply function update processing flow performed by a token supply function calculation unit.

FIG. 12 is a diagram for explaining a token supply processing flow for each communication flow performed by a token supply unit.

FIG. 13 shows an example of an operation of a delay control shaping set value calculation function.

FIG. 14 shows an example of the operation of the delay control shaping set value changing function.

FIG. 15 shows an example of a system configuration according to Embodiment 2.

FIG. 16 shows an example of a configuration of a transmission terminal.

FIG. 17 shows an example of a system configuration according to Embodiment 3.

FIG. 18 shows an example of a configuration of a transmission terminal.

FIG. 19 shows an example of a configuration of a TCP optimization device.

FIG. 20 shows an example of a configuration of a TCP communication unit according to Embodiment 4.

FIG. 21 shows an example of an ACK RTT storage memory.

FIG. 22 shows an example of a configuration of a delay control shaping set value changing function according to Embodiment 3.

FIG. 23 shows an example of a target throughput setting table.

FIG. 24 shows an example of an operation of a delay control shaping set value calculation function.

### DESCRIPTION OF EMBODIMENTS

Hereinafter, embodiments of the present disclosure will be described in detail with reference to the drawings. Note that the present disclosure is not limited to the embodiments described below. These examples are merely illustrative, and the present disclosure can be implemented in various modified and improved modes based on the knowledge of those skilled in the art. Note that constituent elements with the same reference signs in the present specification and the drawings are identical to each other.

### Overview of the Present Disclosure

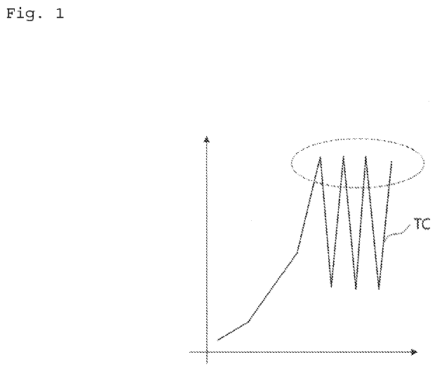

FIGS. 1 to 3 show an application example of shaping related to the present disclosure. A traffic TC in TCP communication from a transmission source to a transmission destination has large burstiness, as shown in FIG. 1.

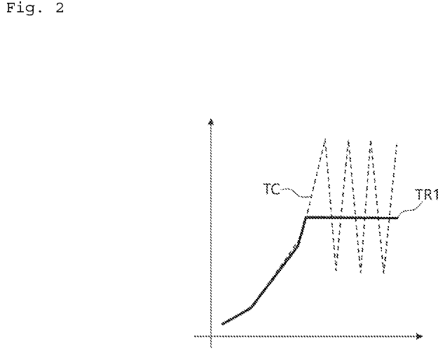

When shaping is performed on the traffic shown in FIG. 1, the maximum bandwidth is suppressed, as in TR1 of FIG. 2.

Therefore, when the shaping is set to a large size, the shaping becomes meaningless.

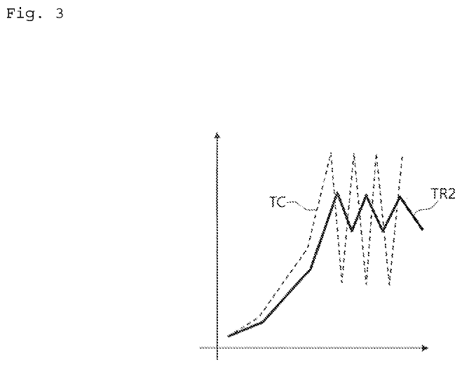

When delay control shaping is performed on the traffic shown in FIG. 1, the burstiness is suppressed as in TR2 of FIG. 3, but the delay becomes large, slowing the rise time.

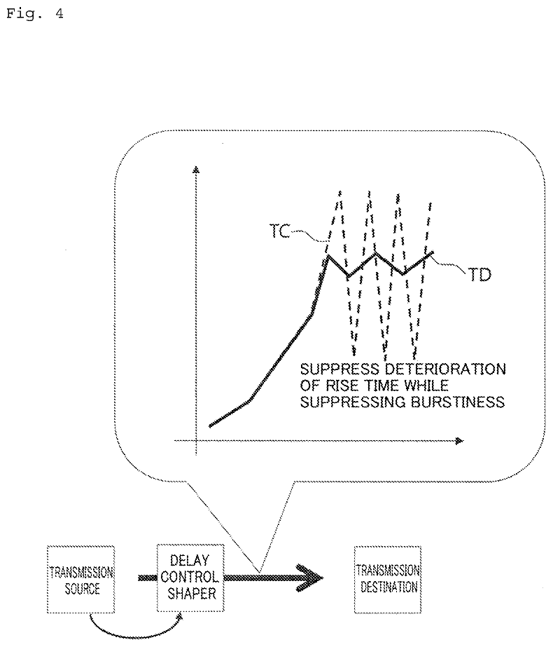

FIG. 4 shows an example of coordination between delay control shaping and a TCP according to the present disclosure. The present disclosure dynamically changes a set value of the delay control shaping, based on a current congestion window size. For example, as shown in TD in FIG. 4, shaping is performed with a small delay fluctuation setting when the congestion window size is small, and shaping is performed with a large delay fluctuation setting when the congestion window size is large. A control cycle is once assumed to be 100 ms or the like, but there is room for consideration in implementation.

A target burst size or a target throughput is set, and an allowable delay fluctuation set value of delay control shaping is determined in such a manner that the target burst size or the target throughput becomes an upper limit. Specifically, a value obtained by dividing the congestion window size of the TCP by the target burst size is set as an allowable delay fluctuation set value. Alternatively, if a value obtained by subtracting RTT from a value obtained by dividing the congestion window size of the TCP by the target throughput is a positive value, this value is set as the allowable delay fluctuation set value.

The location and timing of the control may be arbitrary, and for example, the may be performed at the transmission end, or a TCP optimization device may be provided between the transmission terminal and the reception terminal. This is described specifically hereinafter.

Embodiment 1 below describes a control example in which the burst size is the upper limit. In Embodiment 1, a target burst size is set, and a set value of delay control shaping is controlled based on the target burst size. Specifically, the result of dividing the congestion window size of the TCP by the target burst size is set as an allowable delay fluctuation set value of delay control shaping.

If the congestion window size of the TCP is smaller than the target burst size as a result of this operation, since the allowable delay fluctuation set value is set to be small, delay in expanding the congestion window size in a slow start phase can be suppressed. If the congestion window size of the TCP is larger than the target burst size, since the allowable delay fluctuation set value is set to be large, the burstiness of the traffic when the throughput becomes large can be sufficiently reduced.

Embodiment 4 describes a control example in which the target throughput is the upper limit. In Embodiment 2, a target throughput is set, and a set value of delay control shaping is controlled based on the target throughput. Specifically, if the value obtained by dividing the congestion window size of the TCP by the target throughput and subtracting the RTT measured by the TCP from the obtained allowable communication delay value is positive, said positive value is set as the delay fluctuation set value. If negative, then shaping of delay control shaping is invalidated, and simple packet transfer is performed as the operation.

If the congestion window size of the TCP is smaller than the target throughput as a result of this operation, since the allowable delay fluctuation set value is set to be small, delay in expanding the congestion window size in a slow start phase can be suppressed. If the congestion window size of the TCP is larger than the target throughput, since the allowable delay fluctuation set value is set to be large, the burstiness of the traffic when the throughput becomes large can be sufficiently reduced.

### Embodiment 1

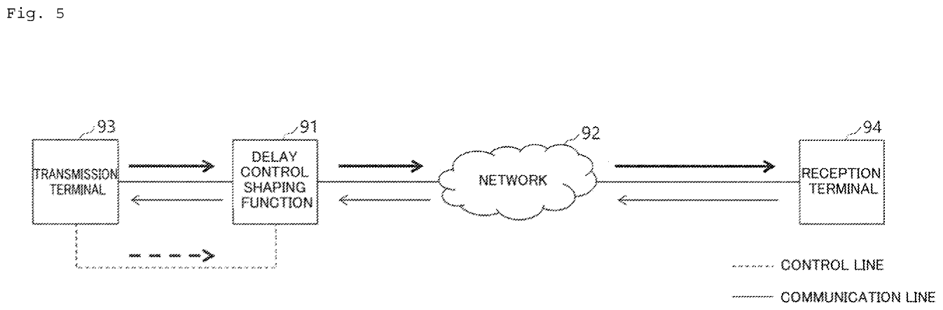

FIG. 5 shows an example of a system configuration according to the present embodiment. A communication system according to the present embodiment is a system in which a transmission terminal 93 performs TCP communication with a reception terminal 94 via a network 92, and includes a delay control shaping function 91 between the transmission terminal 93 and the network 92.

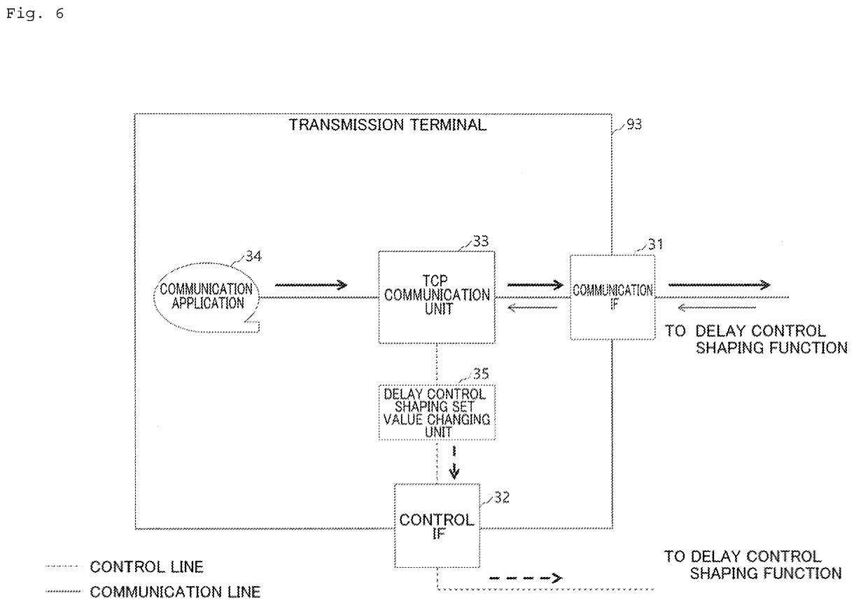

FIG. 6 shows an example of a configuration of the transmission terminal 93. The transmission terminal 93 includes a communication IF (Interface) 31, a control IF 32, a TCP communication unit 33, a communication application 34, and a delay control shaping set value changing unit 35.

The communication IF is connected to a communication IF of the delay control shaping function 91.

The control IF 32 is connected to a control IF of the delay control shaping function 91.

The TCP communication unit 33 performs TCP communication with the reception terminal 94.

The communication application 34 is any application in which the transmission terminal 93 communicates with the reception terminal 94.

The delay control shaping set value changing unit 35 notifies the delay control shaping function 91 of a maximum delay fluctuation Jmax.

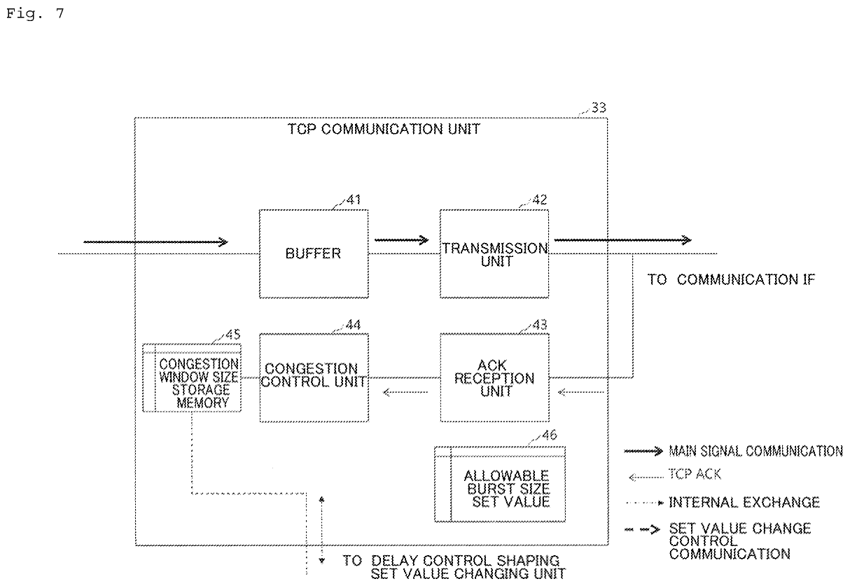

FIG. 7 shows an example of a configuration of the TCP communication unit 33. The TCP communication unit 33 includes a buffer 41, a transmission unit 42, an ACK reception unit 43, a congestion control unit 44, a congestion window size storage memory 45, and an allowable burst size set value 46.

The buffer 41 stores data obtained from the communication application 34.

The transmission unit 42 reads the data stored in the buffer 41 and transmits the data to the communication IF 31.

The ACK reception unit 43 receives an ACK from the reception terminal 94.

The congestion control unit 44 performs congestion control on the basis of the ACK from the reception terminal 94.

The congestion window size storage memory 45 stores a current congestion window size nCW.

The allowable burst size set value 46 stores a preset allowable burst size set value in the TCP communication unit 33.

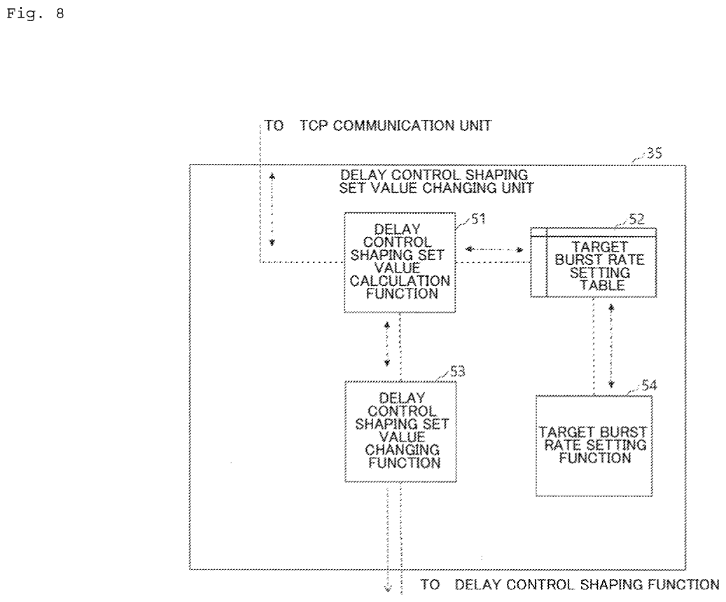

FIG. 8 shows an example of a configuration of the delay control shaping set value changing unit 35. The delay control shaping set value changing unit 35 includes a delay control shaping set value calculation function 51, a target burst rate setting table 52, a delay control shaping set value changing function 53, and a target burst rate setting function 54.

The delay control shaping set value calculation function 51 obtains a delay control shaping set value on the basis of a congestion window size and a target burst rate.

The delay control shaping set value changing function 53 notifies the delay control shaping function 91 of the delay control shaping set value.

The target burst rate setting function 54 sets a target burst rate tBR and stores the target burst rate tBR in the target burst rate setting table 52.

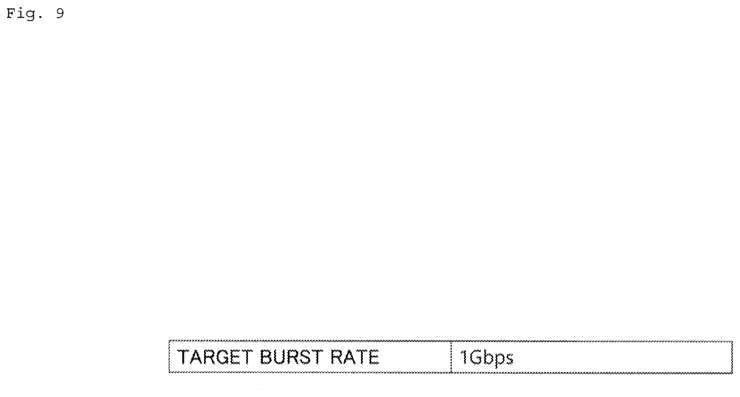

The target burst rate setting table 52 stores the target burst rate tBR. FIG. 9 shows an example of the target burst rate setting table.

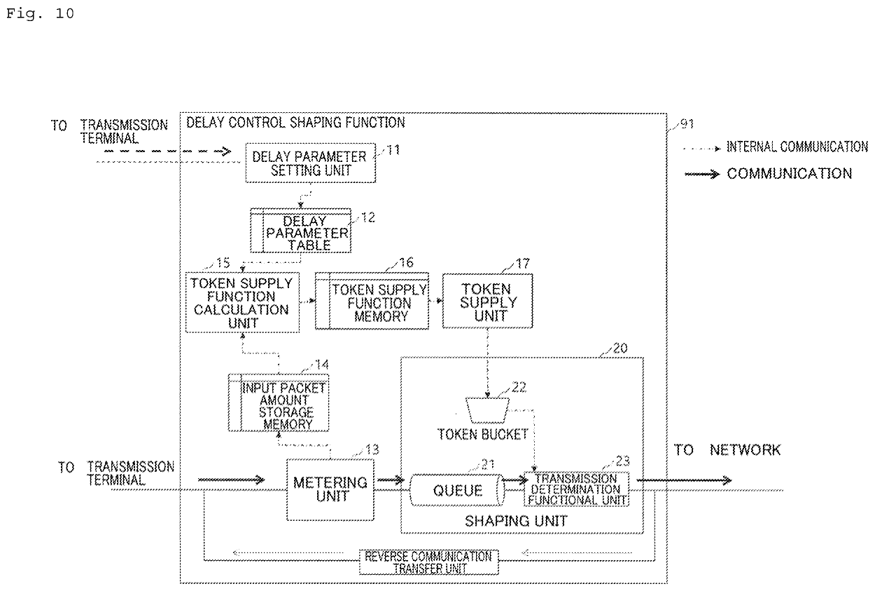

FIG. 10 shows an example of a configuration of the delay control shaping function 91. The delay control shaping function 91 includes a delay parameter setting unit 11, a delay parameter table 12, a metering unit 13, an input packet amount recording memory 14, a token supply function calculation unit 15, a token supply function memory 16, a token supply unit 17, and a shaping unit 20. The shaping unit 20 includes a queue 21, a token bucket 22, and a transmission determination functional unit 23.

The delay parameter setting unit 11 receives the maximum delay fluctuation Jmax from the transmission terminal 93 and stores the maximum delay fluctuation Jmax in the delay parameter table 12.

The delay parameter table 12 stores the maximum delay fluctuation Jmax obtained from the transmission terminal 93.

The metering unit 13 measures a data amount of an input packet received from the transmission terminal 93, and stores the data amount in the queue 21.

The input packet amount recording memory 14 records the data amount of the input packet.

The token supply function calculation unit 15 calculates a token supply function so that the maximum delay fluctuation of the input packet is Jmax.

The token supply function memory 16 stores the token supply function calculated by the token supply function calculation unit 15.

The token supply unit 17 supplies a token to the shaping unit 20 according to the token supply function stored in the token supply function memory 16.

The shaping unit 20 delays the input packet stored in the queue 21 according to the supplied token and transmits the delayed input packet to the receiving terminal 94.

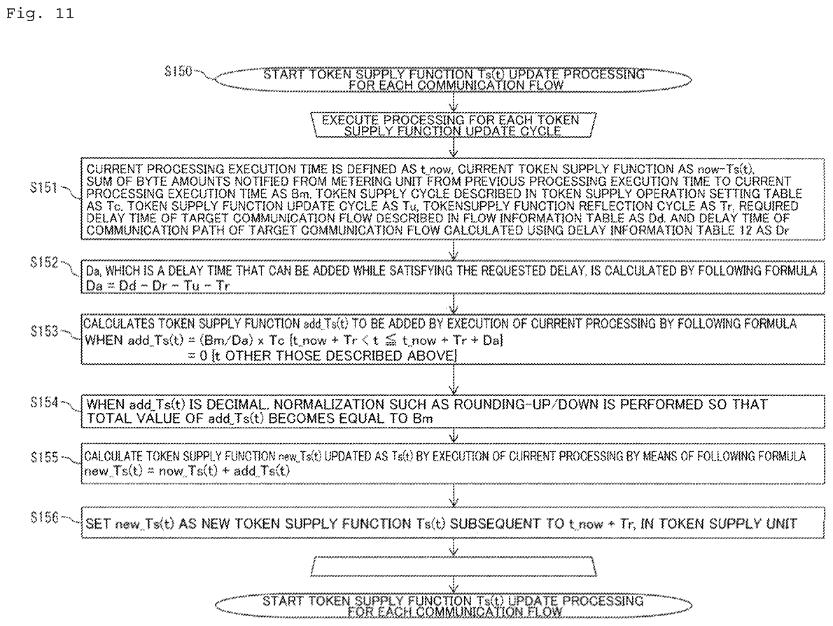

FIG. 11 shows a token supply function Ts(t) update processing flow (S150) for each communication flow executed by the token supply function calculation unit 15. If one supply period in which tokens calculated based on the amount of packets input during one predetermined period overlaps with a subsequent supply period after tokens calculated based on the amount of packets input during a predetermined period after the one predetermined period, then, during the period in which the one supply period overlaps with the subsequent supply period, the token supply amount control function adds the amount of tokens calculated based on the amount of packets input during the subsequent predetermined period to the amount of tokens calculated based on the amount of packets input during the one predetermined period.

This update processing is executed for each token supply function update cycle. A current processing execution time is defined as t_now, a current token supply function as now-Ts(t), a sum of byte amounts notified from the metering unit 13 from a previous processing execution time to the current processing execution time as Bm, a token supply cycle as Tc, a token supply function update cycle as Tu, a token supply function reflection cycle as Tr, a required delay time of a target communication flow as Dd, and a delay time of a communication path of the target communication flow that is calculated using the delay parameter table 12 as Dr (step S151).

Da which is a delay time that can be added while satisfying a required delay is calculated by the following equation (step S152).

Da=Dd−Dr−Tu−Tr

A token supply function add_Ts(t) to be added in the current processing execution is calculated by the following equation (step S153).

If t is t_now+Tr<t<t_now+Tr+Da, add_Ts(t)=(Bm/Da)×Tc (1)

In case of t other than the above-mentioned t, add_Ts(t)=0 (2)

If add_Ts(t) is a decimal, normalization such as rounding-up or rounding-off is performed so that the total value of add_Ts(t) becomes equal to Bm (step S154). A token supply function new_Ts(t), which is updated as Ts(t) in the current processing execution, is calculated by the following equation (step S155).

new_Ts(t)=now_Ts(t)+add_Ts(t)

The token supply function memory 16 is updated with the new_Ts(t) as a new Ts(t) subsequent to t=t_now+Tr, and is set in the token supply unit 17 (step S156).

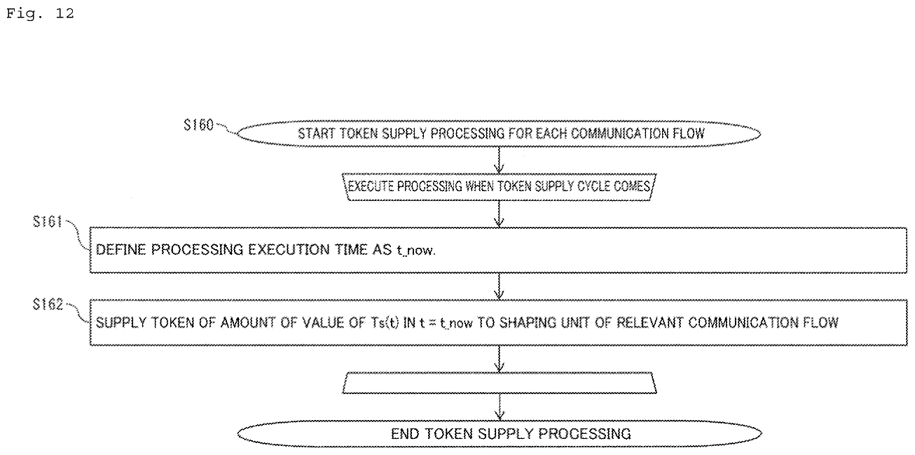

FIG. 12 shows a token supply processing flow (S160) for each communication flow executed by the token supply unit 17. This update processing is executed for each token supply cycle.

The processing execution time is defined as t_now (step S161). A token of the amount of the value of Ts(t) at t=t_now is supplied to the shaping unit 20 of the communication flow (step S162).

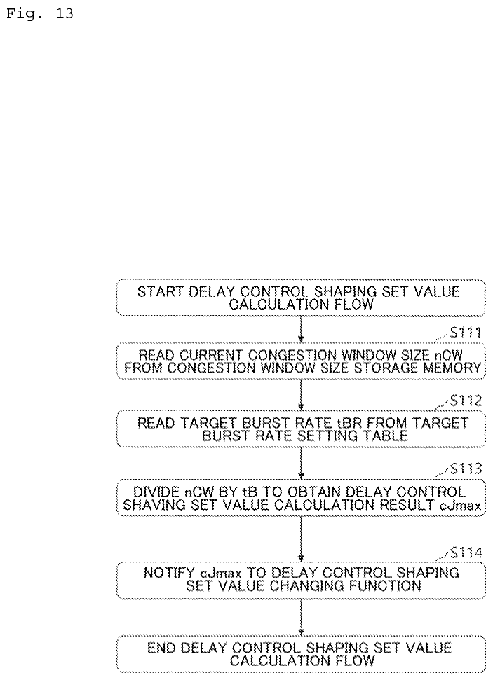

FIG. 13 shows an example of the operation of the delay control shaping set value calculating function 51.

The current congestion window size nCW is read from the congestion window size storage memory 45 (S111).

The target burst rate tBR is read from the target burst rate setting table 52 (S112).

The nCW is divided by tB to obtain a delay control shaping set value calculation result cJmax (S113).

The delay control shaping set value changing function 53 is notified of the cJmax (S114).

The trigger to start the calculation flow may be when a change in the congestion window size is detected or when the congestion window size is changed at regular intervals.

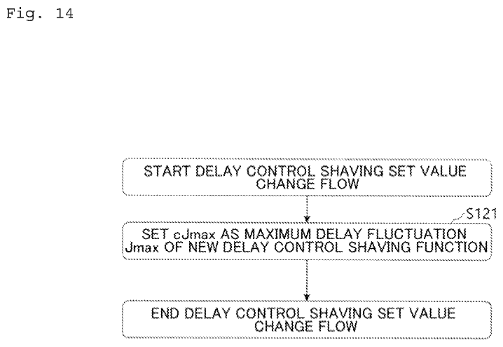

FIG. 14 shows an example of the operation of the delay control shaping set value changing function 53.

The cJmax is set as the maximum delay fluctuation Jmax of a new delay control shaping function (S121).

It should be noted that the setting may be performed immediately, or a method for performing the setting only when a certain provided threshold is exceeded.

### Embodiment 2

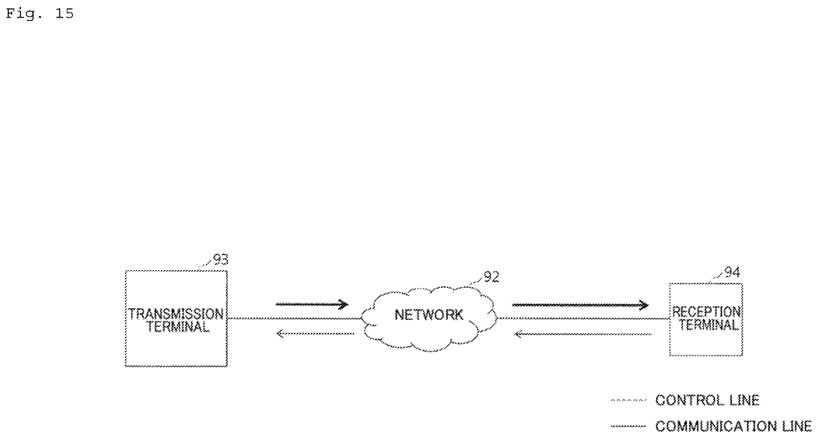

FIG. 15 shows an example of a system configuration according to the present disclosure. A communication system according to the present embodiment is a system in which the transmission terminal 93 performs TCP communication with the reception terminal 94 via the network 92, wherein the transmission terminal 93 has the delay control shaping function.

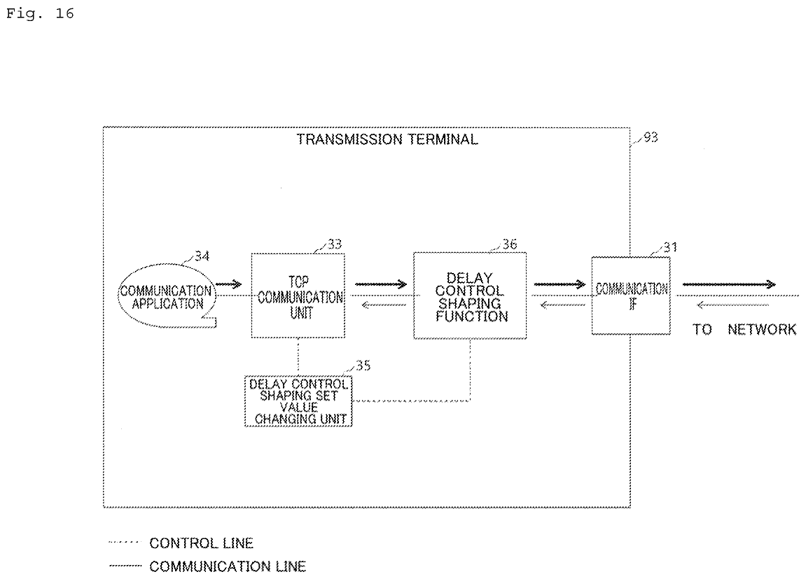

FIG. 16 shows an example of a configuration of the transmission terminal 93. The transmission terminal 93 further includes the delay control shaping set value changing unit 35, and the delay control shaping function 36 is connected between the communication IF 31 and the TCP communication unit 33.

The delay control shaping function 36 includes a function similar to that of the delay control shaping function 91 described in Embodiment 1.

### Embodiment 3

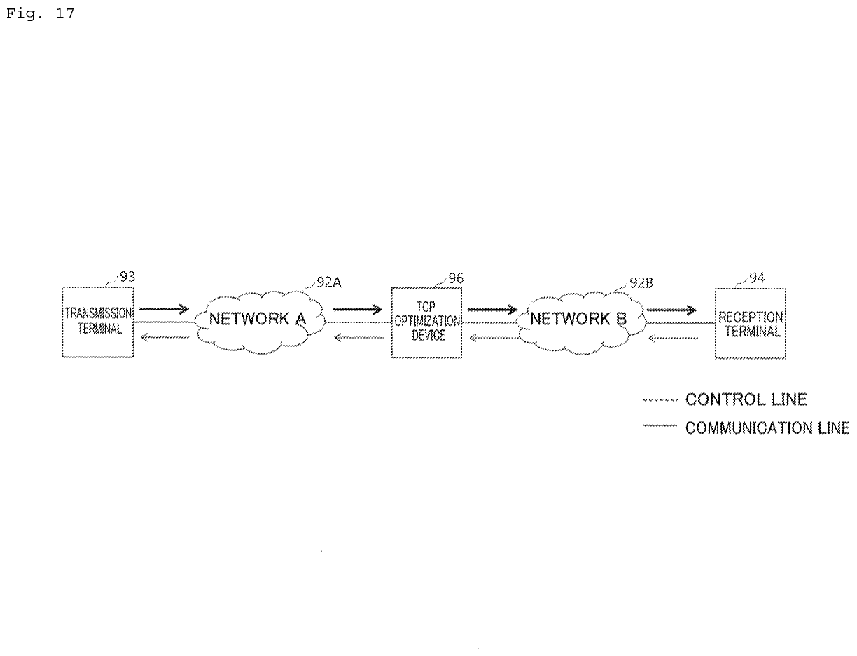

FIG. 17 shows an example of a system configuration according to the present disclosure. A communication system according to the present embodiment is a system in which the transmission terminal 93 performs TCP communication with the reception terminal 94 via the network 92, and includes the delay control shaping function in the network 92.

Specifically, a TCP optimization device 96 is connected between a networks 91A and a network 92B.

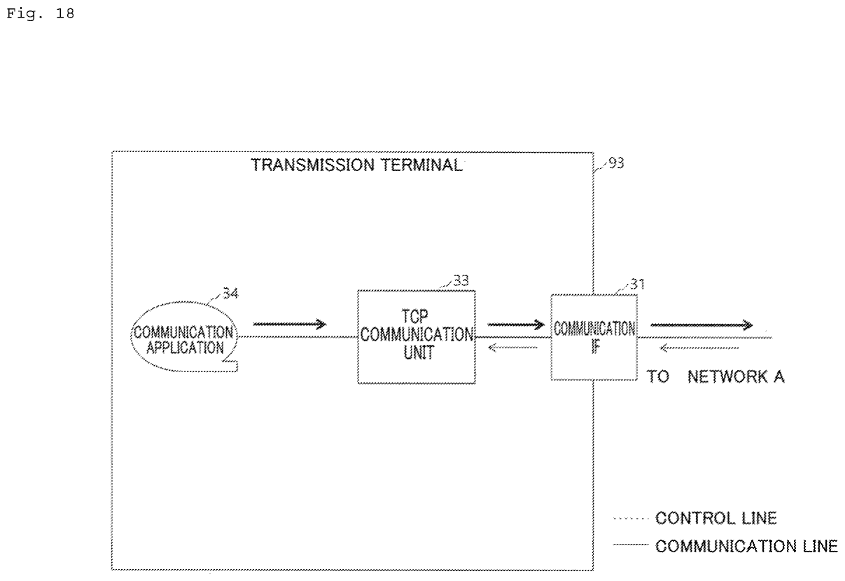

FIG. 18 shows an example of a configuration of the transmission terminal 93. The transmission terminal 93 includes the delay control shaping set value changing unit 35, and the delay control shaping function 36 is connected between the communication IF 31 and the TCP communication unit 33.

The delay control shaping function 36 includes a function similar to that of the delay control shaping function 91 described in Embodiment 1.

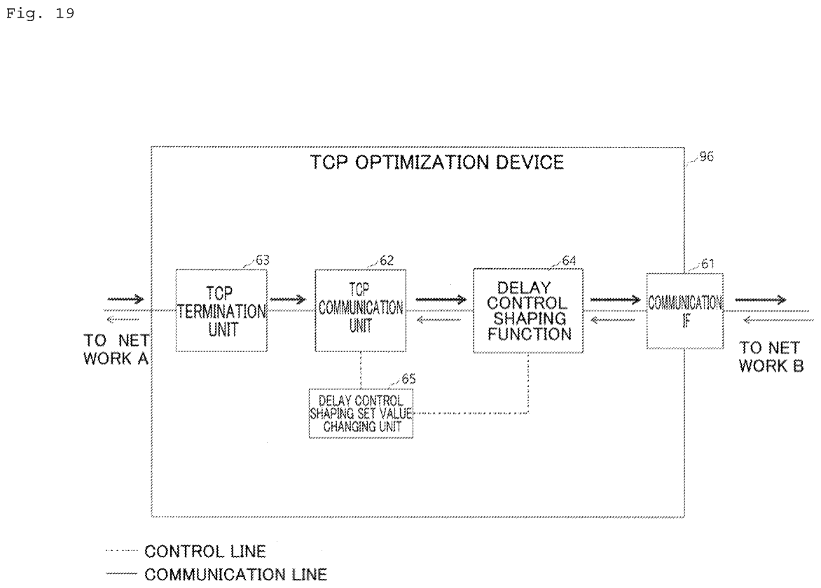

FIG. 19 shows an example of a configuration of the TCP optimization device 96. The TCP optimization device 96 is provided with the delay control shaping function in addition to a function provided in the TCP optimization device described in NPL 4. Specifically, the TCP optimization device 96 includes a communication IF 61, a TCP communication unit 62, a TCP termination unit 63, a delay control shaping function 64, and a delay control shaping set value changing unit 65.

The communication IF 61 is connected to the reception terminal 94 via the network 92B.

The TCP communication unit 62 transmits and receives a TCP packet to and from the reception terminal 94.

The TCP termination unit 63 performs termination processing of a TCP packet. The termination processing is, for example, ACK proxy response.

The delay control shaping function 64 controls the transmission speed of the communication partner side by controlling the ACK proxy response.

The delay control shaping set value changing unit 65 notifies the delay control shaping function 64 of the maximum delay fluctuation Jmax.

### Embodiment 4

In this embodiment, instead of the above-mentioned control example in which the burst size is the upper limit, control in which the target throughput is the upper limit is performed.

A communication system according to the present embodiment differs from those of the foregoing embodiments in the functions of the TCP communication unit 33 and the delay control shaping set value changing unit 35. The features of the control in which the target throughput is the upper limit will be described hereinafter.

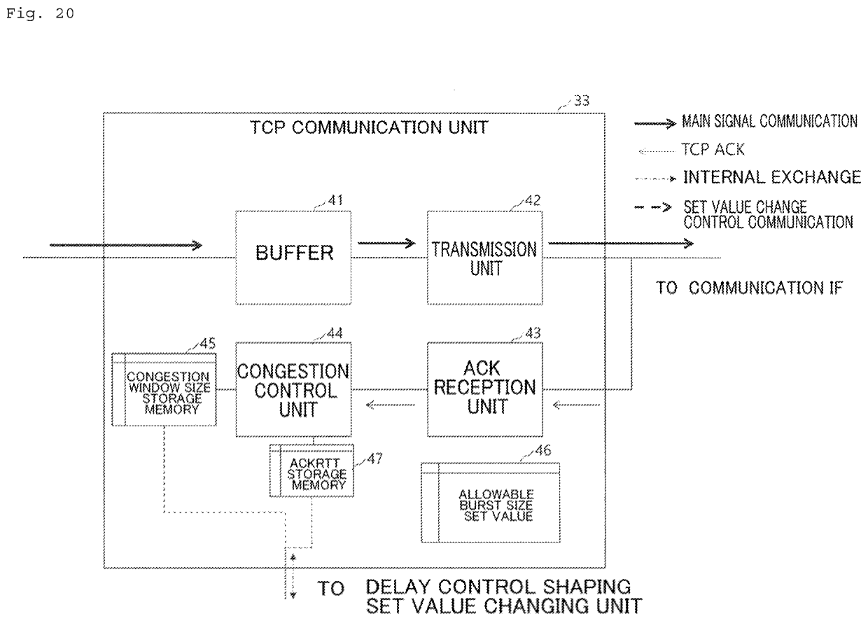

FIG. 20 shows an example of a configuration of the TCP communication unit 33. The TCP communication unit 33 includes an ACK RTT storage memory 47 in addition to the buffer 41, the transmission unit 42, the ACK reception unit 43, the congestion control unit 44, the congestion window size storage memory 45, and the allowable burst size set value 46.

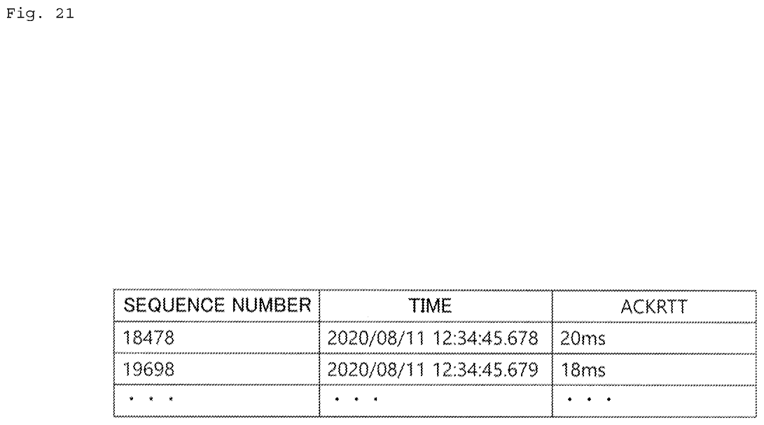

Upon reception of an ACK packet, the ACK reception unit 43 subtracts an ACK packet reception time from a TCP packet transmission time at which the ACK reception unit 43 transmits the TCP packet, to calculate an ACK RTT. The calculated ACK RTT is stored in the ACK RTT storage memory 47. FIG. 21 shows an example of the ACK RTT storage memory.

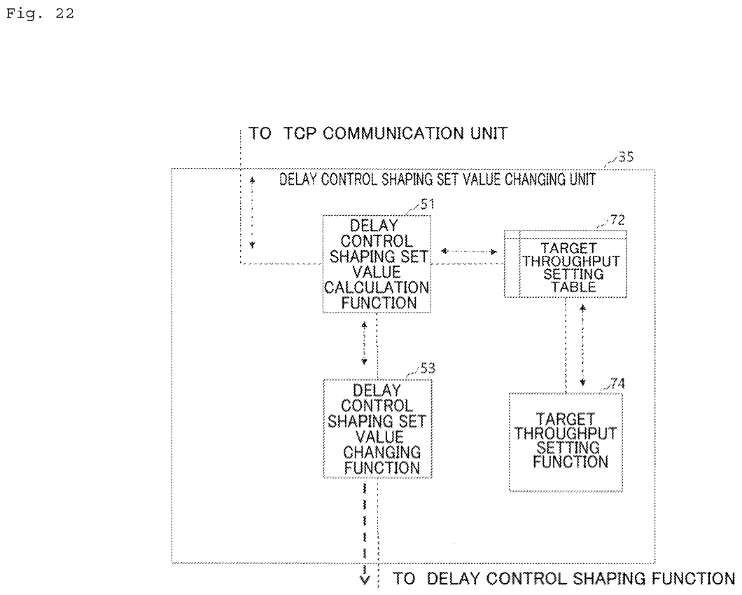

FIG. 22 shows an example of a configuration of the delay control shaping set value changing unit 35. The delay control shaping set value changing unit 35 is provided with a target throughput setting table 72 and a target throughput setting function 74 in place of the target burst rate setting table 52 and the target burst rate setting function 54.

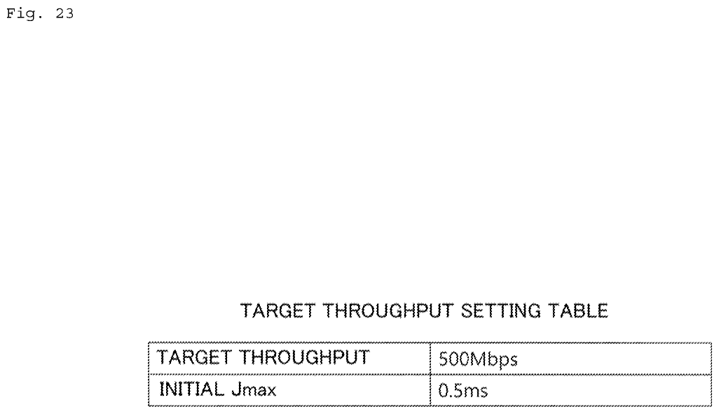

The target throughput setting table 72 stores a target throughput tTh. FIG. 23 shows an example of the target burst rate setting table.

The target throughput setting function 74 sets the target throughput tTh and stores the target throughput tTh in the target throughput setting table 72.

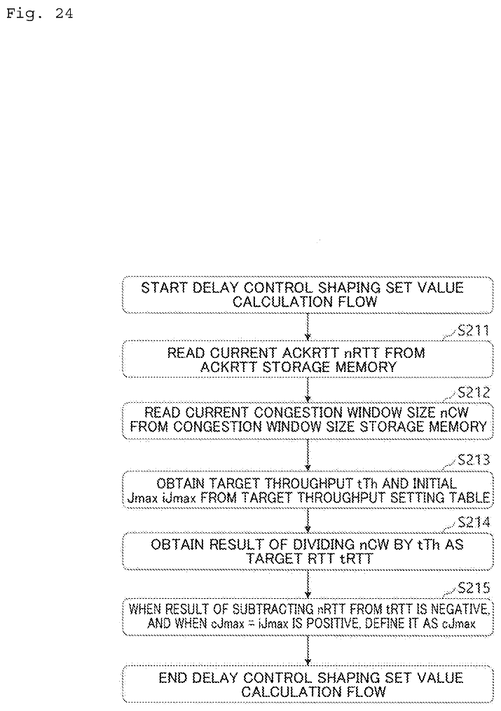

FIG. 24 shows an example of the operation of the delay control shaping set value calculating function 51 of the present embodiment.

A current ACKRTT nRTT is read from the ACKRTT storage memory (S211).

The current congestion window size nCW is read from the congestion window size storage memory (S212).

The target throughput tTh and an initial Jmax iJmax are obtained from the target throughput setting table 72 (S213).

The result obtained by dividing the nCW by the tTh is obtained as a target RTT tRTT (S214).

If the result of subtracting the nRTT from the tRTT is negative, and if cJmax=iJmax is positive, this is taken as cJmax (S215).

In the present embodiment, a target throughput is set, and a set value of delay control shaping is controlled based on the target throughput. If the congestion window size of the TCP is smaller than the target throughput as a result of this operation, since the allowable delay fluctuation set value is set to be small, delay in expanding the congestion window size in a slow start phase can be suppressed. Therefore, the present embodiment can reduce the burstiness of the traffic in the TCP without causing a window size expansion delay and a decrease in maximum throughput.

The device of the present disclosure can also be achieved by a computer and a program, and the program can be recorded in a recording medium or provided through a network.

### INDUSTRIAL APPLICABILITY

The present disclosure is applicable to information and communication industries.

### REFERENCE SIGNS LIST

11 Delay parameter setting unit
12 Delay parameter table
13 Metering unit
14 Input packet amount recording memory
15 Token supply function calculation unit
16 Token supply function memory
17 Token supply unit
20 Shaping unit
21 Queue
22 Token bucket
23 Transmission determination functional unit
31 Communication IF
32 Control IF
33 TCP communicating unit
34 Communication application
35 Delay control shaping set value changing unit
36 Delay control shaping function
41 Buffer
42 Transmission unit
43 ACK reception unit
44 Congestion control unit
45 Congestion window size storage memory
46 Allowable burst size set value
47 ACK RTT storage memory
51 Delay control shaping set value calculation function
52 Target burst rate setting table
53 Delay control shaping set value changing function
54 Target burst rate setting function
61 Communication IF
62 TCP communicating unit
63 TCP termination unit
64 Delay control shaping function
72 Target throughput setting table
74 Target throughput setting function
91 Delay control shaping function
92 Network
93 Transmission terminal
94 Reception terminal

1. A communication system for transmitting a packet from a transmission terminal to a reception terminal, comprising:
a processor; and
a storage medium having computer program instructions stored thereon, when executed by the processor:
performs congestion control of a packet transmitted from the transmission terminal; and changes a set value of delay control shaping based on a setting of a congestion window size on which the congestion control unit performs congestion.

2. The communication system according to claim 1, wherein the computer program instructions further perform to set a target burst size or a target throughput, and controls the set value of the delay control shaping on the basis of the target burst size or the target throughput.

3. The communication system according to claim 1, wherein the delay control shaping unit divides the congestion window size by the target burst size and sets a value obtained by the division as an allowable delay fluctuation set value of the delay control shaping.

4. The communication system according to claim 1, wherein the delay control shaping unit acquires a round-trip delay time from the transmission terminal to the reception terminal, divides the congestion window size by the target throughput, and if a value obtained by subtracting the round-trip delay time from a value obtained by the division is a positive value, sets the value obtained as a result of the division as a delay fluctuation set value.

5. A shaping method executed by a communication system transmitting a packet from a transmission terminal to a reception terminal, the shaping method including a step in which a congestion control unit performs congestion control of a packet transmitted from the transmission terminal, and a step in which a delay control shaping unit changes a set value of delay control shaping based on a setting of a congestion window size on which the congestion control unit performs congestion.

6. A device for performing shaping of a packet transmitted from a transmission terminal, the device receiving a packet transmitted from the transmission terminal, acquiring a congestion window size of congestion control to be performed on the packet of the transmission terminal, and changing a set value of delay control shaping based on a setting of the congestion window size.

7. A program for causing a computer to implement each of functions provided in the device according to claim 6.
